(19) United States
(12) Patent Application Publication
(10) Pub. No.: US 2025/0276802 A1
(43) Pub. Date: Sep. 4, 2025

(54) METHOD FOR OPERATING AN AIRCRAFT, AND AIRCRAFT

(71) Applicant: ROLLS-ROYCE DEUTSCHLAND LTD & CO KG, Blankenfelde-Mahlow (DE)

(72) Inventors: Carsten CLEMEN, Mittenwalde (DE); Max STAUFER, Berlin (DE)

(21) Appl. No.: 19/061,286

(22) Filed: Feb. 24, 2025

(30) Foreign Application Priority Data
Feb. 29, 2024 (DE) 10 2024 201 869.4

(51) Int. Cl. B64D 37/30; B64D 31/00

(52) U.S. Cl. CPC B64D 37/30; B64D 31/00

(57) ABSTRACT

The invention relates to a method for operating an aircraft with a gaseous fuel, in particular hydrogen, and a liquid fuel, in particular a sustainable alternative fuel and/or kerosene, wherein the gaseous fuel and the liquid fuel are supplied in parallel or alternatively to each other to a combustion chamber of at least one engine of the aircraft. An optimized method with regard to efficiency and pollutant emissions is provided in that the aircraft is operated at least temporarily with a constant flow of gaseous fuel, while the liquid fuel flow is varied.

This application claims priority to German Patent Application 102024201869.4 filed Feb. 29, 2024, the entirety of which is incorporated by reference herein.

The invention relates to a method for operating an aircraft with a gaseous fuel, in particular hydrogen, and a liquid fuel, in particular a sustainable alternative fuel and/or kerosene, wherein the gaseous fuel and the liquid fuel are supplied in parallel or alternatively to each other to a combustion chamber of at least one engine of the aircraft. The invention also relates to an aircraft which is designed for operating with a gaseous fuel and with a liquid fuel, to a computer program and to a control device.

In the case of known methods of the abovementioned type, during operation with the different fuels (gaseous and liquid, “dual fuel” operation), the aircraft is normally operated initially exclusively with the gaseous fuel and then exclusively with the liquid fuel. This requires a combustion chamber system that can burn both the gaseous and the liquid fuel independently of each other, while complying with all the legal regulations regarding safety (e.g. relighting at altitude), emissions and the like. This is usually accompanied by a loss of system quality compared to a combustion chamber system which is designed and optimized only for operation with one type of fuel, in particular with regard to efficiency and emissions, such as particulates or nitrogen oxides (NOₓ).

The invention is based on the object of providing a method of the type mentioned at the beginning, which is optimized with regard to efficiency and pollutant emissions, and a correspondingly designed aircraft, a computer program and a control device.

The object is achieved for the method by the features of claim 1, for the aircraft by the features of claim 8, for the computer program by the features of claim 9 and for the control device by the features of claim 10.

The method provides that the aircraft is operated at least temporarily with an at least substantially constant flow of gaseous fuel, while the liquid fuel flow is varied.

“At least substantially” means, for example, with deviations within the fuel flow of less than 5% from a setpoint value.

The aircraft is designed to carry out the method according to the invention. In this case, it has at least one engine designed for at least temporarily parallel operation with the gaseous fuel and the liquid fuel. In particular, all of the engines of the aircraft are correspondingly designed. In the combustion chamber system, the engine can have fuel nozzles which are designed both for operation with the gaseous fuel, in particular with hydrogen, and with the liquid fuel, the nozzle/nozzles being operable in parallel (simultaneously) with the two types of fuel and preferably at least exclusively with hydrogen. Alternatively or additionally, the engine can have two different types of fuel nozzles, one type being operable exclusively with the gaseous fuel, in particular hydrogen, and the other type exclusively with the liquid fuel.

To achieve simple open-loop and/or closed-loop controllability, the aircraft (with the at least one engine) is preferably operated with the constant flow of gaseous fuel over several operating phases, while the liquid fuel flow is varied, in particular depending on the operating phase and/or the required engine control.

Preferably, the aircraft (in a first exemplary mode of operation) is operated with the constant flow of gaseous fuel from an operating phase of idling, in particular immediately after an operating phase of ignition (with starting of the at least one engine) until an operating phase of off (with shutdown of the at least one engine) at the end of the entire operating period of a flight mission (operation of the aircraft from a starting location to a destination location, from ignition until shutdown of the engines). Alternatively, the aircraft (in a second exemplary mode of operation) can be operated with the constant flow of gaseous fuel from (and including) an operating phase of taxiing before an operating phase of take-off to an (and including the) operating phase of taxiing after an operating phase of landing of a flight mission. In the second mode of operation, the engine or aircraft is operated during idling with the flow of (exclusively) gaseous fuel required during idling. The continuous or at least predominantly parallel operation makes it possible for the combustion chamber system of the engine (in particular the engine in question) to be configured much more efficiently and in particular with regard to emissions of a higher quality than a combustion chamber system which is operated with two fuels alternatively to each other.

Preferably, it is provided that the amount of constant flow (setpoint value) of gaseous fuel corresponds at maximum, for example, at least substantially, to the required flow for operating the engine while the aircraft is taxiing (i.e. the flow required during the “operating phase of taxiing”) and/or at least substantially to the flow of gaseous fuel for operating the engine during idling exclusively with the gaseous fuel. “At least substantially” means, for example, with a deviation of less than 30%, preferably less than 15% from the fuel flow during taxiing and/or idling. In this way, ground operations of the aircraft can advantageously be carried out exclusively or with a large proportion of gaseous fuel, in particular hydrogen as fuel, as a result of which the emission characteristics of the aircraft (in particular with regard to particulate emissions and CO₂) on the ground are positively influenced.

In a preferred embodiment of the method, the engine is ignited exclusively with the gaseous fuel. In addition to the ignition on the ground during regular operation, this also relates to the relighting at a high altitude (“altitude relight”). In particular, the fuel flow of gaseous fuel is lower than during idling. The ignition process within the engine can thus be significantly improved because of the better ignition properties and combustion stability of hydrogen, with, for example, the open-loop and/or closed-loop control of the ignition process also being significantly simplified. In addition, only the ignition with the gaseous fuel needs to be taken into account when certifying the engine.

Preferably, the liquid fuel is switched on for operating phases in which the power of the engine exceeds the power in the operating phase of idling and/or in the operating phase of taxiing, the engine being operated in parallel with the (constant flow of) gaseous fuel, in particular hydrogen, and the liquid fuel. This relates, in particular, to the operating phases of take-off, cruising and/or landing and optionally the operating phases of taxiing in the case of the first exemplary mode of operation. The liquid fuel flow is in particular adjusted or varied taking into account the constant flow of hydrogen. Thus advantageously, in contrast to the liquid fuel, hydrogen can be burnt only to a comparatively small extent at altitude. In this way, the discharge of water and nitrogen oxides (NOₓ) in altitude operation is significantly reduced compared to operation with pure hydrogen. Both types have a much higher climate impact (in terms of greenhouse gases) at altitude than carbon dioxide (CO₂).

Preferably, the gaseous fuel is stored and/or provided in gaseous or liquid form, the gaseous fuel when stored and/or provided in liquid form being evaporated before being supplied to the combustion chamber. For this purpose, the aircraft has at least one correspondingly designed tank device and fuel peripherals for supplying the combustion chamber system (in particular the combustion chamber system in question) of the engine (in particular the engine in question).

The aircraft according to the invention is designed for operating with a gaseous fuel and with a liquid fuel, which fuels are supplied at least temporarily in parallel to at least one engine (preferably to all the engines in parallel) of the aircraft, and comprises a control device which is designed for operating the aircraft according to a method according to the invention.

The computer program comprises commands which cause the aircraft according to the invention to be operated by a method according to the invention.

In addition, the aircraft has a control device on which this computer program is stored.

The invention will be explained in more detail in the following text by way of exemplary embodiments with reference to the drawings, in which:

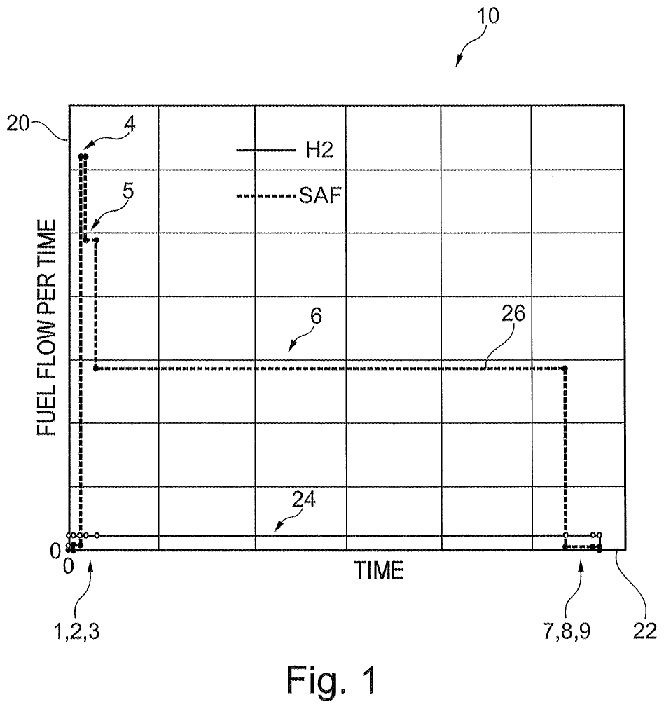

FIG. 1 shows a diagram with a fuel flow per time over time for a total operating time of an aircraft in an exemplary flight mission in parallel operation,

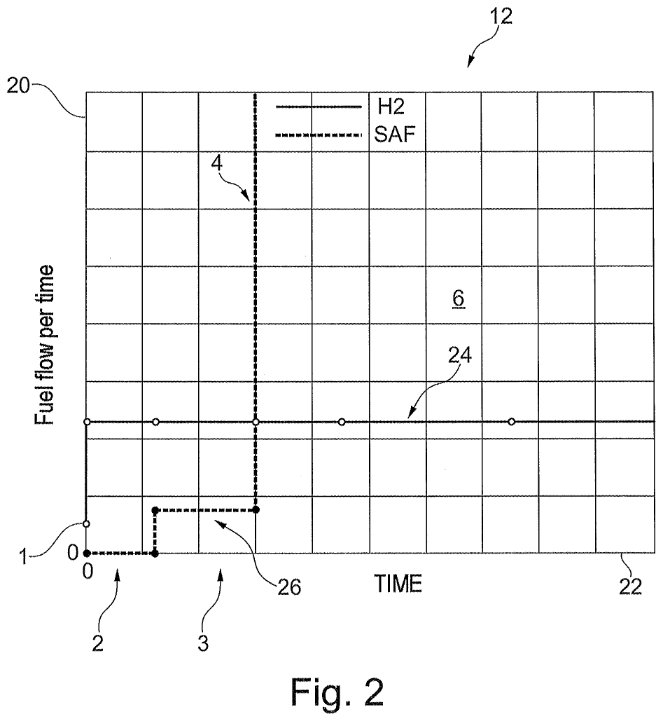

FIG. 2 shows a diagram with an enlarged illustration of the diagram according to FIG. 1, with a first part of the flight mission, and

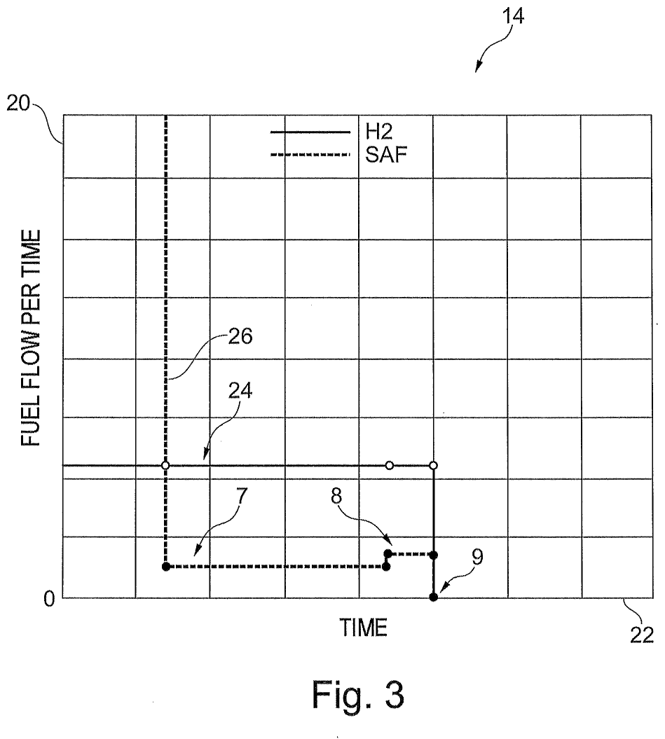

FIG. 3 shows a diagram with an enlarged illustration of the diagram according to FIG. 1, with a second part of the flight mission.

FIG. 1 shows a diagram 10 with a fuel flow (as mass flow) per time 20 over time 22 for a total operating time of an exemplary flight mission of an aircraft, which is operated by a method according to the invention according to an exemplary first operating mode. On the flight mission, the aircraft is operated with gaseous fuel, in particular hydrogen (H₂), and a liquid fuel, in particular kerosene or a sustainable alternative fuel (SAF). In diagram 10, operation with hydrogen is shown with reference to a hydrogen flow 24 by means of a solid line, and operation with liquid fuel is shown with reference to a liquid fuel flow 26 by means of a dashed line.

FIG. 1 illustrates the entire flight mission, with different operating phases corresponding substantially to the flight phases of the aircraft. The operating phases sequentially comprise an operating phase of ignition 1, an operating phase of idling 2, an operating phase of taxiing 3, an operating phase of take-off 4, an operating phase of climbing 5, an operating phase of cruising 6, an operating phase of landing 7, an operating phase of taxiing 8 and an operating phase of off 9.

The operating phase of ignition 1 corresponds to a comparatively short operating phase within which an engine of the aircraft, preferably a plurality of engines, is/are ignited. In the operating phase of take-off 4, the maximum power take-off (MTO) of the engine is used to generate the take-off thrust. Within the operating phase of off 9, the engine is shut down.

FIG. 2 shows, in a diagram 12, an enlarged illustration of FIG. 1 with a first part of the flight mission, comprising the operating phases of ignition 1, idling 2 and taxiing 3 before the operating phase of take-off 4.

FIG. 3 shows, in a diagram 14, an enlarged illustration of FIG. 1 with a second part of the flight mission, comprising the operating phases of landing 7, taxiing 8 and off 9.

The range of the flight mission is, for example, 6000 km at a cruising speed of 800 km/h.

In an operation known from the prior art with both gaseous fuel and liquid fuel (“dual fuel” operation), the at least one engine is operated exclusively with hydrogen within the first part of the flight and exclusively with the liquid fuel within the second (usually longer) part of the flight. In the exemplary flight mission, during the first part, e.g. the first 1200 km, including the ground operations at the take-off location, with the first operating phases of ignition 1, idling 2, taxiing 3, take-off 4, climbing 5 and the first part of cruising 6, the aircraft is operated exclusively with hydrogen. Subsequently, the second part, with the remaining 4800 km, including the ground operations at the landing site, during the operating phases of cruising 6, landing 7 and taxiing 8 until the operating phase of off 9, is operated exclusively with the liquid fuel (also see table).

An overview of the operating phases with the fuels used during the flight mission indicated above by way of example and according to the prior art, with switching over, and according to the method according to the invention, with parallel operation according to the first and a second exemplary mode of operation, is summarized in the following table:

| | | Fuel in parallel operation |
|---|---|---|
| | Fuel, Operation with | according to the invention |
| Operating | switching over | (first OR second mode of |
| phase | (prior art) | operation) |
| Ignition 1 | Ignition H2 | Ignition H2 |
| Idling 2 | H2 for idling | H2 for idling (idling H2) |
| Taxiing 3 | H2 for taxiing | (Idling H2 + SAF) for taxiing |
| | | OR H2 for taxiing |
| Take-off 4 | H2 for take-off | ((Idling H2 + SAF) OR (H2 for |
| | | taxiing + SAF)) for take-off |
| Climbing 5 | H2 for climbing | ((Idling H2 + SAF) OR (H2 for |
| | | taxiing + SAF)) for climbing |
| Cruising 6 | H2 for cruising | ((Idling H2 + SAF) OR (H2 for |
| | | taxiing + SAF)) for cruising |
| Cruising 6 | SAF for cruising | ((Idling H2 + SAF) OR (H2 for |
| | | taxiing + SAF)) for cruising |
| Landing 7 | SAF for landing | ((Idling H2 + SAF) OR (H2 for |
| | | taxiing + SAF)) for landing |
| Taxiing 8 | SAF for taxiing | ((Idling H2 + SAF) OR (H2 for |
| | | taxiing + SAF)) for taxiing |
| Off 9 | — | — |

In contrast to the indicated known flight operation, the aircraft in the method according to the invention is preferably operated over substantially the entire operating time, or at least substantially in ground operation, with a constant flow of gaseous fuel, here the hydrogen flow 24.

In the first mode of operation, e.g. apart from the operating phase of ignition 1, the constant hydrogen flow 24 corresponds in terms of amount in particular to the hydrogen flow for operating the engine (or the engines) exclusively with hydrogen during idling. In the second exemplary mode of operation, not shown in FIG. 1 (also see table), the constant hydrogen flow from the operating phase of taxiing 3 before the operating phase of take-off 4 to the operating phase of taxiing 8 after the operating phase of landing 7 corresponds to the constant hydrogen flow required for the operating phases of taxiing 3, 8. In this way, ground operations of the aircraft can advantageously be carried out exclusively or with a large proportion of hydrogen as fuel, as a result of which the emission characteristics of the aircraft (in particular with regard to particulate emissions and CO₂) on the ground are positively influenced.

In parallel (simultaneously) with the constant hydrogen flow 24, the liquid fuel flow 26 is switched on at higher engine powers than in the operating phase of idling 2 and is varied when the required engine power changes, in particular depending on the operating phases, as shown by way of example in FIG. 1, FIG. 2 and FIG. 3.

In this way, advantageously, in contrast to the liquid fuel, hydrogen is burnt only to a comparatively small extent at altitude. Thus, the discharge of water and nitrogen oxides (NOₓ) in altitude operation is significantly reduced compared to operation with pure hydrogen. Both types have a much higher climate impact (in terms of greenhouse gases) at altitude than carbon dioxide (CO₂).

For a comparable flight mission, the same amount of gaseous fuel and liquid fuel is required during operation according to the prior art and according to the method according to the invention (“parallel operation”).

In the method according to the invention, preferably in the operating phase of ignition 1, the engine is started with hydrogen, with the combustion chamber of the engine (in particular the engine in question) being ignited in particular exclusively with hydrogen. Then, during the operating phase of idling 2, exclusively the hydrogen flow 24 is supplied to the engine, i.e. the engine is operated exclusively with hydrogen. At the beginning of the operating phase of taxiing 3, the hydrogen flow 24 is furthermore kept constant and the liquid fuel flow 26 is switched on. The liquid fuel flow 26 is adjusted or varied over the further operating time to achieve the following operating phases of the aircraft, such as the operating phase of take-off 4, with the maximum engine power for the take-off thrust, climbing 5, cruising 6, etc., taking into account the constant hydrogen flow 24.

Preferably, every ignition of the engine is carried out with hydrogen, which, in addition to the illustrated operating phase of ignition 1, can also relate to a relighting of the engine that may be required at altitude (not shown here). In this way, the ignition process within the engine can be significantly improved because of the better ignition properties and combustion stability of hydrogen. The open-loop and/or closed-loop control of the ignition process is also substantially simplified.

The gaseous fuel, in particular hydrogen, can be stored and/or provided in gaseous or liquid form within the aircraft. When the hydrogen is stored and/or provided in liquid form, it is preferably evaporated before being supplied to the combustion chamber. The amount stored in a suitable tank device (not shown here) is coordinated with the corresponding flight mission in such a way that the aircraft can be operated with the constant hydrogen flow 24 for at least substantially the entire operating time. For safety reasons, additional fuel carried along is, for example, at least predominantly formed by the liquid fuel.

In addition, the aircraft has a control device, in particular a flight unit, which is configured for the aircraft operation according to the invention. In particular, a computer program comprising commands which cause the aircraft to be operated with the method according to the invention is stored on the control device.

Owing to the (almost) continuous or predominant combination or parallel operation (e.g. except for the operating phases of ignition 1 and idling 2, and possibly taxiing 3, 8), the combustion chamber system of the engine can be designed much more efficiently and in line with requirements and only requires certification for this operating mode. Emissions can be effectively reduced in total.

### LIST OF REFERENCE SIGNS

1 Operating phase of ignition
2 Operating phase of idling
3 Operating phase of taxiing
4 Operating phase of take-off
5 Operating phase of climbing
6 Operating phase of cruising
7 Operating phase of landing
8 Operating phase of taxiing
9 Operating phase of off
10 Diagram
12 Diagram
14 Diagram
20 Fuel flow per time
22 Time
24 Hydrogen flow
26 Liquid fuel flow

1. A method for operating an aircraft with a gaseous fuel, in particular hydrogen, and a liquid fuel, in particular a sustainable alternative fuel and/or kerosene, wherein the gaseous fuel and the liquid fuel are supplied in parallel or alternatively to each other to a combustion chamber of at least one engine of the aircraft, wherein the aircraft is operated at least temporarily with a constant flow of gaseous fuel, while the liquid fuel flow is varied.

2. The method according to claim 1, wherein the aircraft is operated with the constant flow of gaseous fuel over several operating phases, while the liquid fuel flow is varied, in particular depending on the operating phase and/or a required engine control.

3. The method according to claim 2, wherein the aircraft is operated with the constant flow of gaseous fuel from an operating phase of idling, in particular immediately after an operating phase of ignition until an operating phase of off at the end of the entire operating period of a flight mission or from an operating phase of taxiing before an operating phase of take-off until an operating phase of taxiing after an operating phase of landing.

4. The method according to claim 1, wherein the amount of constant flow of gaseous fuel corresponds at maximum, for example, at least substantially, to the required flow of gaseous fuel for operating the engine while the aircraft is taxiing and/or at least substantially to the flow of gaseous fuel for operating the engine during idling exclusively with the gaseous fuel.

5. The method according to claim 1, wherein the engine is ignited exclusively with the gaseous fuel.

6. The method according to claim 3, wherein the liquid fuel is switched on for operating phases in which the power of the engine exceeds the power in the operating phase of idling and/or in the operating phase of taxiing, the engine being operated in parallel with the gaseous fuel and the liquid fuel.

7. The method according to claim 1, wherein the gaseous fuel is stored and/or provided in gaseous or liquid form, the gaseous fuel when stored and/or provided in liquid form being evaporated before being supplied to the combustion chamber.

8. An aircraft which is designed for operating with a gaseous fuel and with a liquid fuel, which fuels are supplied at least temporarily in parallel to at least one engine of the aircraft, with a control device which is designed for operating the aircraft according to a method according to claim 1.

9. A computer program comprising commands which cause the aircraft according to claim 8 to be operated.

10. A control device on which the computer program according to claim 9 is stored.
